(19) United States
(12) Patent Application Publication
(10) Pub. No.: US 2026/0257429 A1
(43) Pub. Date: Sep. 3, 2026

(54) CHEMICALLY RESISTANT ULTRASONICALLY WELDABLE PARTS AND ULTRASONICALLY WELDED ARTICLES THEREOF

(71) Applicant: SHPP GLOBAL TECHNOLOGIES B.V., Bergen op Zoom (NL)

(72) Inventors: Hao GU, Bergen op Zoom (NL); Erik SCHWARTZ, Eindhoven (NL); Petrus Jacobus AKKERMANS, Steenbergen (NL); Richard SCHOUWENAAR, Kapelle (NL); Robert Dirk VAN DE GRAMPEL, Tholen (NL); Mark Adrianus Johannes VAN DER MEE, Etten Leur (NL)

(21) Appl. No.: 18/879,631

(22) PCT Filed: Jun. 29, 2023
(86) PCT No.: PCT/IB2023/056774

§ 371 Date: Dec. 27, 2024

(30) Foreign Application Priority Data
Jun. 30, 2022 (EP) 22182262.0

(51) Int. Cl. B29C 65/00; B29C 65/08; C08G 77/448

(52) U.S. Cl. CPC B29C 66/71; B29C 65/08; C08G 77/448

(57) ABSTRACT

An ultrasonically weldable part comprising improved weld strength and chemical resistance comprises a thermoplastic composition comprising a poly(carbonate-siloxane) composition comprising: a poly(carbonate-siloxane) comprising 30 to 70 wt % siloxane repeating units present in an amount effective to provide less than 6 wt % siloxane repeating units, based on the total weight of the thermoplastic composition, or a poly(carbonate-siloxane) comprising 30 to 70 wt % siloxane repeating units and a poly(carbonate-siloxane) comprising 2 wt % to less than 30 wt % siloxane repeating units, optionally, a polycarbonate, and optionally an additive composition, wherein the siloxane domain of a molded sample of the thermoplastic composition has an average diameter of 70 nm or less, measured using atomic force microscopy.

### BACKGROUND

This disclosure relates to ultrasonically weldable parts, and in particular to chemically resistant ultrasonically weldable parts, methods of manufacture, and articles thereof.

Polycarbonates are useful in the manufacture of articles and components for a wide range of applications, from automotive parts to electronic appliances. Because of their broad use, particularly in healthcare and electronics, it is desirable to provide polycarbonates that are ultrasonically weldable.

There accordingly remains a need in the art for ultrasonically weldable thermoplastic compositions. It would be a further advantage if the thermoplastic compositions were also chemically resistant.

### SUMMARY

The above-described and other deficiencies of the art are met by an ultrasonically weldable part comprising a thermoplastic composition comprising: a poly(carbonate-siloxane) composition comprising: a poly(carbonate-siloxane) comprising 30 to 70 wt % siloxane repeating units present in an amount effective to provide less than 6 wt % siloxane repeating units, based on the total weight of the thermoplastic composition, or a poly(carbonate-siloxane) comprising 30 to 70 wt % siloxane repeating units, and a poly(carbonate-siloxane) comprising 2 wt % to less than 30 wt % siloxane repeating units, optionally, a polycarbonate, and optionally an additive composition, wherein the siloxane domain of a molded sample of the thermoplastic composition has an average diameter of 70 nm or less, measured using atomic force microscopy.

In another aspect, a method for forming the ultrasonically weldable part comprises molding, extruding, or shaping the above-described thermoplastic composition to form the ultrasonically weldable part.

In yet another aspect, an ultrasonically welded article comprises the above-described ultrasonically weldable part.

In still another aspect, a method for forming the above-described ultrasonically welded article comprises welding the above-described ultrasonically weldable part to another thermoplastic part to provide the ultrasonically welded article.

The above described and other features are exemplified by the following drawings, detailed description, examples, and claims.

### BRIEF DESCRIPTION OF THE DRAWINGS

The following is a brief description of the drawings wherein like elements are numbered alike and which are exemplary of the various aspects described herein.

FIGS. 1-2 show atomic force microscopy (AFM) photographs at 2 μm (FIG. 1) and 5 μm (FIG. 2) of the surfaces of molded samples of Comparative Examples 1, 5 and 6 and Example 8.

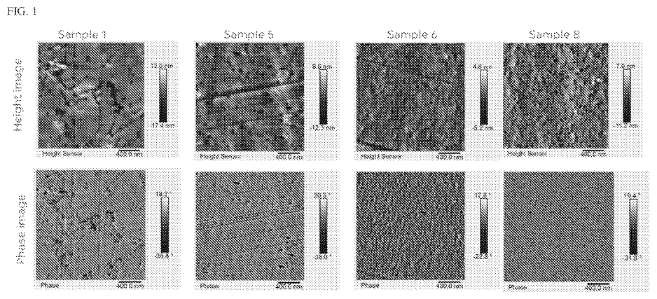

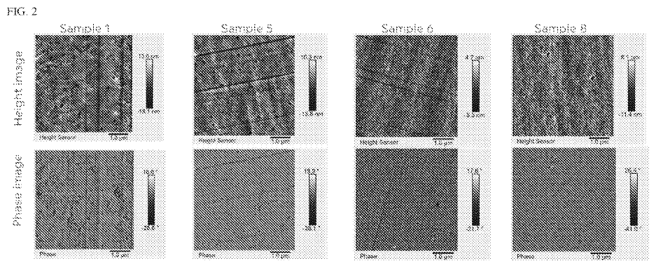

### DETAILED DESCRIPTION

Ultrasonic welding is one of the most popular assembly technologies in the world. It is particularly useful in healthcare applications because it prevents the introduction of contaminants or sources of degradation to the weld, ensuring biocompatibility of the medical device, for example. Ultrasonic assembly can be used to join thermoplastic components and is accomplished by converting high frequency electrical energy into high frequency mechanical motion. Ultrasonic plastic welding usually works by conversion of high frequency (25-40 kHz) ultrasonic energy into low amplitude (1-25 μm) mechanical vibrations. That mechanical motion, along with applied force, creates frictional heat where the two thermoplastic components meet (i.e. “joint interface”). As the thermoplastic melts, it flows and wets the joint interface. Diffusion and entanglement of polymer chains of the thermoplastics across the weld area results in weld formation after cooling.

Conventional compositions including combinations of a polycarbonate and a poly(carbonate-siloxane) have 30-70 wt % siloxane repeating units, based on the weight of the poly(carbonate-siloxane) have good chemical resistance, but do not provide ultrasonically welded articles with good weld strength. Although poly(carbonate-siloxane) s comprising a lower wt % of siloxane repeating units have been used to prepare ultrasonically weldable articles when impact modifiers are present, the articles thereof have inferior chemical resistance.

Under conditions for preparing an ultrasonically welded part, poly(carbonate-siloxane) s tend to form regions in the part with very high siloxane content (“siloxane domains”) and other regions that are deficient in siloxane content. The presence of siloxane domains that are not homogenously dispersed can lead to aesthetic defects in the ultrasonically welded part. AFM can be used to study the surface morphology of ultrasonically weldable parts. In particular, it allows for the determination of the size and uniformity of the siloxane domains. The inventors have discovered a correlation between the size of the siloxane domains and the weld strength of ultrasonically welded articles prepared from ultrasonically weldable parts with good weld strength (e.g., at least 25 MPa). Those articles comprising good well strength were prepared from ultrasonically weldable parts comprising siloxane domains with an average size of 70 nanometers and less (nm) as measured by AFM that were well-dispersed (i.e., homogenous) throughout the molded parts and articles thereof.

The ultrasonically weldable parts were prepared from thermoplastic compositions that include particular poly(carbonate-siloxane) compositions including one or more poly(carbonate-siloxane) s and optionally a polycarbonate that is different from the one or more poly(carbonate-siloxane) s. The thermoplastic compositions are discussed in more detail below.

“Polycarbonate” as used herein means a polymer comprising repeating structural carbonate units of formula (1)

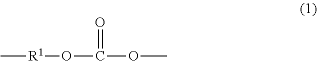

in which at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ can be derived from an aromatic dihydroxy compound of the formula HO—R¹—OH, in particular of formula (2)

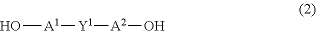

wherein each of A¹ and A² is a monocyclic divalent aromatic group and Y¹ is a single bond or a bridging group comprising one or more atoms that separate A¹ from A². In an aspect, one atom separates A¹ from A². Preferably, each R¹ can be derived from a bisphenol of formula (3)

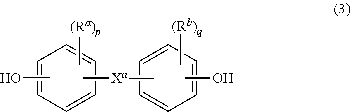

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂—, —C(O)—, or a C₁₋₆₀ organic group. The organic bridging group can be cyclic or acyclic, aromatic or non-aromatic, and can further comprise heteroatoms such as halogens, oxygen, nitrogen, sulfur, silicon, or phosphorous. The C₁₋₆₀ organic group can be disposed such that the C₆ arylene groups connected thereto are each connected to a common alkylidene carbon or to different carbons of the C₁₋₆₀ organic bridging group. In an aspect, p and q is each 1, and R^{a} and R^{b} are each a C₁₋₃ alkyl group, preferably methyl, disposed meta to the hydroxy group on each arylene group.

In an aspect, X^{a} is a C₃₋₁₈ cycloalkylidene, a C₁₋₂₅ alkylidene of formula-C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula-C(═R^{e})— wherein R^{e} is a divalent C₁₋₁₂ hydrocarbon group. Groups of these types include methylene, cyclohexylmethylidene, ethylidene, neopentylidene, and isopropylidene, as well as 2-[2.2.1]-bicycloheptylidene, cyclohexylidene, 3,3-dimethyl-5-methylcyclohexylidene, cyclopentylidene, cyclododecylidene, and adamantylidene.

In another aspect, X^{a} is a C₁₋₁₈ alkylene, a C₃₋₁₈ cycloalkylene, a fused C₆₋₁₈ cycloalkylene, or a group of the formula -J¹-G-J²- wherein J¹ and J² are the same or different C₁₋₆ alkylene and G is a C₃₋₁₂ cycloalkylidene or a C₆₋₁₆ arylene.

For example, X^{a} can be a substituted C₃₋₁₈ cycloalkylidene of formula (4)

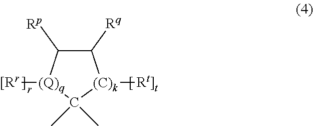

wherein R^{r}, R^{p}, R^{q}, and R^{t} are each independently hydrogen, halogen, oxygen, or C₁₋₁₂ hydrocarbon groups; Q is a direct bond, a carbon, or a divalent oxygen, sulfur, or —N(Z)— where Z is hydrogen, halogen, hydroxy, C₁₋₁₂ alkyl, C₁₋₁₂ alkoxy, C₆₋₁₂ aryl, or C₁₋₁₂ acyl; r is 0 to 2, tis 1 or 2, q is 0 or 1, and k is 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (4) will have an unsaturated carbon-carbon linkage where the ring is fused. When k is one and q is 0, the ring as shown in formula (4) contains 4 carbon atoms, when k is 2, the ring as shown in formula (4) contains 5 carbon atoms, and when k is 3, the ring contains 6 carbon atoms. In an aspect, two adjacent groups (e.g., R^{q} and R^{t} taken together) form an aromatic group, and in another aspect, R^{q} and R^{t} taken together form one aromatic group and R^{f} and R^{p} taken together form a second aromatic group. When R^{q} and R^{t} taken together form an aromatic group, R^{p} can be a double-bonded oxygen atom, i.e., a ketone, or Q can be —N(Z)— wherein Z is phenyl.

Bisphenols wherein X^{a} is a cycloalkylidene of formula (4) can be used in the manufacture of polycarbonates containing phthalimidine carbonate units of formula (Ia)

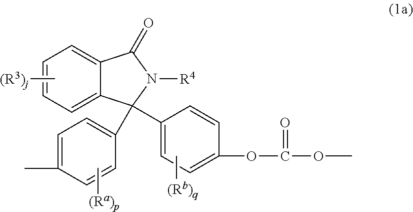

wherein R^{a}, R^{b}, p, and q are as in formula (3), R³ is each independently a C₁₋₆ alkyl, j is 0 to 4, and R₄ is hydrogen, C₁₋₆ alkyl, or a substituted or unsubstituted phenyl, for example a phenyl substituted with up to five C₁₋₆ alkyls. For example, the phthalimidine carbonate units are of formula (1b)

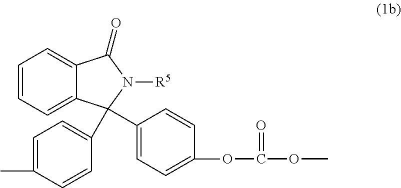

wherein R⁵ is hydrogen, phenyl optionally substituted with up to five 5 C₁₋₆ alkyls, or C₁₋₄ alkyl. In an aspect in formula (1b), R⁵ is hydrogen, methyl, or phenyl, preferably phenyl. Carbonate units (1b) wherein R⁵ is phenyl can be derived from 2-phenyl-3,3′-bis(4-hydroxy phenyl)phthalimidine (also known as 3,3-bis(4-hydroxyphenyl)-2-phenylisoindolin-1-one, or N-phenyl phenolphthalein bisphenol (“PPPBP”)).

Other bisphenol carbonate repeating units of this type are the isatin carbonate units of formula (1c) and (1d)

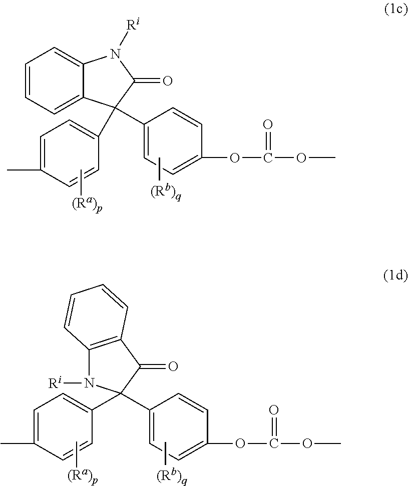

wherein R^{a} and R^{e} are each independently a halogen, C₁₋₁₂ alkoxy, or C₁₋₁₂ alkyl, p and q are each independently 0 to 4, and R¹ is C₁₋₁₂ alkyl, phenyl optionally substituted with 1 to 5 C₁₋₁₀ alkyl, or benzyl optionally substituted with 1 to 5 C₁₋₁₀ alkyl. In an aspect, R^{a} and R^{b} are each methyl, p and q are each independently 0 or 1, and R¹ is C₁₋₄ alkyl or phenyl.

Other examples of bisphenol carbonate units derived from of bisphenols (3) wherein X^{a} is a substituted or unsubstituted C₃₋₁₈ cycloalkylidene include the cyclohexylidene-bridged bisphenol of formula (1e)

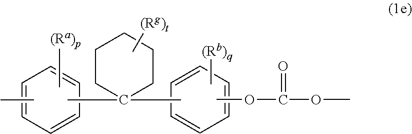

wherein R^{a} and R^{b} are each independently C₁₋₁₂ alkyl, R& is C₁₋₁₂ alkyl, p and q are each independently 0 to 4, and t is 0 to 10. In a specific aspect, at least one of each of R^{a} and R^{b} are disposed meta to the cyclohexylidene bridging group. In an aspect, R^{a} and R^{b} are each independently C₁₋₄ alkyl, R⁸ is C₁₋₄ alkyl, p and q are each 0 or 1, and tis 0 to 5. In another specific aspect, R^{a}, R^{b}, and R^{g} are each methyl, p and q are each 0 or 1, and t is 0 or 3, preferably 0. In still another aspect, p and q are each 0, each R& is methyl, and tis 3, such that X^{a} is 3,3-dimethyl-5-methyl cyclohexylidene.

Examples of other bisphenol carbonate units derived from bisphenol (3) wherein X^{a} is a substituted or unsubstituted C₃₋₁₈ cycloalkylidene include adamantyl units of formula (If) and fluorenyl units of formula (1g)

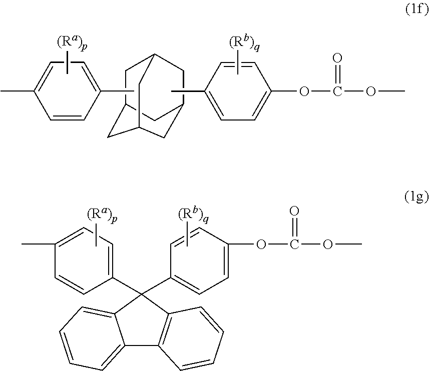

wherein R^{a} and R^{b} are each independently C₁₋₁₂ alkyl, and p and q are each independently 1 to 4. In a specific aspect, at least one of each of R^{a} and R^{b} are disposed meta to the cycloalkylidene bridging group. In an aspect, R^{a} and R^{b} are each independently C₁₋₃ alkyl, and p and q are each 0 or 1; preferably, R^{a}, R^{b} are each methyl, p and q are each 0 or 1, and when p and q are 1, the methyl group is disposed meta to the cycloalkylidene bridging group. Carbonates containing units (1a) to (1g) are useful for making polycarbonates with high glass transition temperatures (Tg) and high heat distortion temperatures.

Other useful dihydroxy compounds of the formula HO—R¹—OH include aromatic dihydroxy compounds of formula (6)

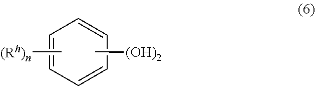

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen is usually bromine.

Some illustrative examples of specific dihydroxy compounds include the following: 4,4′-dihydroxybiphenyl, 1,6-dihydroxynaphthalene, 2,6-dihydroxynaphthalene, bis(4-hydroxyphenyl) methane, bis(4-hydroxyphenyl)diphenylmethane, bis(4-hydroxyphenyl)-1-naphthylmethane, 1,2-bis(4-hydroxyphenyl) ethane, 1,1-bis(4-hydroxyphenyl)-1-phenylethane, 2-(4-hydroxyphenyl)-2-(3-hydroxyphenyl) propane, bis(4-hydroxyphenyl)phenylmethane, 2,2-bis(4-hydroxy-3-bromophenyl) propane, 1,1-bis(hydroxyphenyl)cyclopentane, 1,1-bis(4-hydroxyphenyl)cyclohexane, 1,1-bis(4-hydroxyphenyl) isobutene, 1,1-bis(4-hydroxyphenyl)cyclododecane, trans-2,3-bis(4-hydroxyphenyl)-2-butene, 2,2-bis(4-hydroxyphenyl) adamantane, alpha, alpha′-bis(4-hydroxyphenyl) toluene, bis(4-hydroxyphenyl) acetonitrile, 2,2-bis(3-methyl-4-hydroxyphenyl) propane, 2,2-bis(3-ethyl-4-bydroxyphenyl) propane, 2,2-bis(3-n-propyl-4-hydroxyphenyl) propane, 2,2-bis(3-isopropyl-4-hydroxyphenyl) propane, 2,2-bis(3-sec-butyl-4-hydroxyphenyl) propane, 2,2-bis(3-t-butyl-4-hydroxyphenyl) propane, 2,2-bis(3-cyclohexyl-4-hydroxyphenyl) propane, 2,2-bis(3-allyl-4-hydroxyphenyl) propane, 2,2-bis(3-methoxy-4-hydroxyphenyl) propane, 2,2-bis(4-hydroxyphenyl) bexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′ dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl) ether, bis(4-bydroxyphenyl) ether, bis(4-hydroxyphenyl) sulfide, bis(4-hydroxyphenyl) sulfoxide, bis(4-hydroxyphenyl) sulfone, 9,9-bis(4-hydroxyphenyl) fluorine, 2,7-dihydroxypyrene, 6,6′-dihydroxy-3,3,3′,3′-tetramethylspiro(bis) indane (“spirobiindane bisphenol”), 3,3-bis(4-hydroxyphenyl) phthalimide, 2,6-dihydroxydibenzo-p-dioxin, 2,6-dihydroxythianthrene, 2,7-dibydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or a combination thereof.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). A combination can also be used. In a specific aspect, the polycarbonate is a linear homopolymer derived from bisphenol A, in which each of A¹ and A² is p-phenylene and Y¹ is isopropylidene in formula (3).

The polycarbonates can have an intrinsic viscosity, as determined in chloroform at 25° C., of 0.3 to 1.5 deciliters per gram (dl/gm), preferably 0.45 to 1.0 dl/gm. The polycarbonates can have a weight average molecular weight (Mw) of 10,000 to 200,000 g/mol, preferably 20,000 to 100,000 g/mol, as measured by gel permeation chromatography (GPC), using a crosslinked styrene-divinylbenzene column and polystyrene standards and calculated for polycarbonate. GPC samples are prepared at a concentration of 1 mg per ml, and are eluted at a flow rate of 1.5 ml per minute.

One or more linear homopolycarbonates can be present. For example, the linear homopolycarbonate can comprise a bisphenol A homo polycarbonate comprising a weight average molecular weight of 15,000 to 25,000 g/mol or 17,000 to 23,000 g/mol or 18,000 to 22,000 g/mol, a bisphenol A homopolycarbonate comprising a weight average molecular weight of 26,000 to 40,000 g/mol or 26,000 to 35,000 g/mol, or a combination thereof, each measured by GPC according to polystyrene standards and calculated for polycarbonate. The weight ratio of the linear homopolycarbonates relative to one another is 10:1 to 1:10, or 5:1 to 1:5, or 3:1 to 1:3, or 2:1 to 1:2, or 1:1.

When present, the linear homopolycarbonate(s) can be present in an amount of 1-99 wt %, based on the total weight of the thermoplastic composition.

“Polycarbonates” includes homopolycarbonates (wherein each R¹ in the polymer is the same), copolymers comprising different R¹ moieties in the carbonate (“copolycarbonates”), and copolymers comprising carbonate units and other types of polymer units, such as ester units or siloxane units.

The polycarbonate can be an aromatic poly(ester-carbonate). Such polycarbonates further contain, in addition to recurring carbonate units of formula (1), repeating ester units of formula (3)

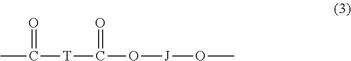

wherein J is a divalent group derived from an aromatic dihydroxy compound (including a reactive derivative thereof), such as a bisphenol of formula (2), e.g., bisphenol A; and T is a divalent group derived from an aromatic dicarboxylic acid (including a reactive derivative thereof), preferably isophthalic or terephthalic acid wherein the weight ratio of isophthalic acid to terephthalic acid is 91:9 to 2:98. Copolyesters containing a combination of different T or J groups can be used. The polyester units can be branched or linear.

In an aspect, J is derived from a bisphenol of formula (2), e.g., bisphenol A. In another aspect, J is derived from an aromatic dihydroxy compound, e.g., resorcinol. A portion of the groups J, for example up to 20 mole percent (mol %) can be a C₂₋₃₀ alkylene group comprising a straight chain, branched chain, or cyclic (including polycyclic) structure, for example ethylene, n-propylene, i-proplyene, 1,4-butylene, 1,4-cyclohexylene, or 1,4-methylenecyclohexane. Preferably, all J groups are aromatic.

Aromatic dicarboxylic acids that can be used to prepare the polyester units include isophthalic or terephthalic acid, 1,2-di(p-carboxyphenyl) ethane, 4,4′-dicarboxydiphenyl ether, 4,4′-bisbenzoic acid, or a combination thereof. Acids containing fused rings can also be present, such as in 1,4-, 1,5-, or 2,6-naphthalenedicarboxylic acids. Specific dicarboxylic acids include terephthalic acid, isophthalic acid, naphthalene dicarboxylic acid, or a combination thereof. A specific dicarboxylic acid comprises a combination of isophthalic acid and terephthalic acid wherein the weight ratio of isophthalic acid to terephthalic acid is 91:9 to 2:98. A portion of the groups T, for example up to 20 mol %, can be aliphatic, for example derived from 1,4-cyclohexane dicarboxylic acid. Preferably all T groups are aromatic.

The molar ratio of ester units to carbonate units in the polycarbonates can vary broadly, for example 1:99 to 99:1, preferably 10:90 to 90:10, more preferably 25:75 to 75:25, or 2:98 to 15:85, depending on the desired properties of the final composition.

Specific poly(ester-carbonate) s are those including bisphenol A carbonate units and isophthalate/terephthalate-bisphenol A ester units, i.e., a poly(bisphenol A carbonate)-co-(bisphenol A-phthalate-ester) of formula (4a)

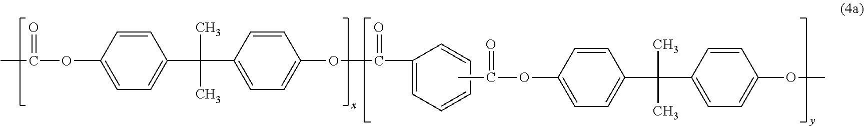

wherein x and y represent the weight percent of bisphenol A carbonate units and isophthalate/terephthalate-bisphenol A ester units, respectively. Generally, the units are present as blocks. In an aspect, the weight ratio of carbonate units x to ester units y in the polycarbonates is 1:99 to 50:50, or 5:95 to 25:75, or 10:90 to 45:55. Copolymers of formula (5) comprising 35-45 wt % of carbonate units and 55-65 wt % of ester units, wherein the ester units have a molar ratio of isophthalate to terephthalate of 45:55 to 55:45 are often referred to as poly(carbonate-ester) s (PCE). Copolymers comprising 15-25 wt % of carbonate units and 75-85 wt % of ester units, wherein the ester units have a molar ratio of isophthalate to terephthalate from 98:2 to 88:12 are often referred to as poly(phthalate-carbonate) s (PPC).

In another aspect, the high heat poly(ester-carbonate) is a poly(carbonate-co-monoarylate ester) of formula (4b) that includes aromatic carbonate units (1) and repeating monoarylate ester units

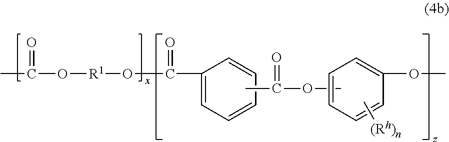

wherein R¹ is as defined in formula (1), and each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0-4. Preferably, each R^{h} is independently a C₁₋₄ alkyl, and n is 0-3, 0-1, or 0. The mole ratio of carbonate units x to ester units z can be from 99:1 to 1:99, or from 98:2 to 2:98, or from 90:10 to 10:90. In an aspect the mole ratio of x:z is from 50:50 to 99:1, or from 1:99 to 50:50.

In an aspect, the high heat poly(ester-carbonate) comprises aromatic ester units and monoarylate ester units derived from the reaction of a combination of isophthalic and terephthalic diacids (or a reactive derivative thereof) with resorcinol (or a reactive derivative thereof) to provide isophthalate/terephthalate-resorcinol (“ITR” ester units). The ITR ester units can be present in the high heat poly(ester-carbonate) in an amount greater than or equal to 95 mol %, preferably greater than or equal to 99 mol %, and still more preferably greater than or equal to 99.5 mol %, based on the total moles of ester units in the polycarbonate. A preferred high heat poly(ester-carbonate) comprises bisphenol A carbonate units, and ITR ester units derived from terephthalic acid, isophthalic acid, and resorcinol, i.e., a poly(bisphenol A carbonate-co-isophthalate/terephthalate-resorcinol ester) of formula (c)

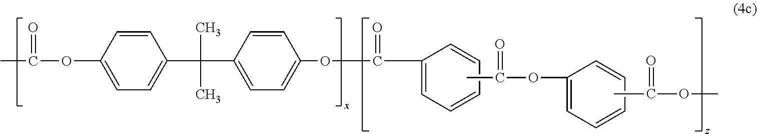

wherein the mole ratio of x:z is from 98:2 to 2:98, or from 90:10 to 10:90. In an aspect the mole ratio of x:z is from 50:50 to 99:1, or from 1:99 to 50:50. The ITR ester units can be present in the poly(bisphenol A carbonate-co-isophthalate-terephthalate-resorcinol ester) in an amount greater than or equal to 95 mol %, preferably greater than or equal to 99 mol %, and still more preferably greater than or equal to 99.5 mol %, based on the total moles of ester units in the copolymer. Other carbonate units, other ester units, or a combination thereof can be present, in a total amount of 1 to 20 mole %, based on the total moles of units in the copolymers, for example monoaryl carbonate units of formula (5) and bisphenol ester units of formula (3a):

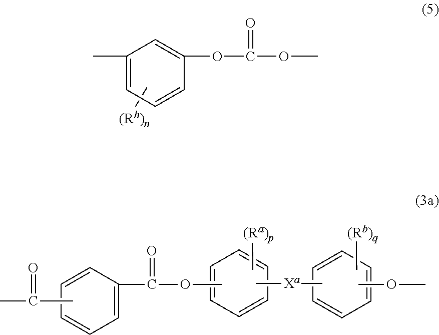

wherein, in the foregoing formulae, R^{h} is each independently a C₁₋₁₀ hydrocarbon group, n is 0-4, R^{a} and R^{b} are each independently a C₁₋₁₂ alkyl, p and q are each independently integers of 0-4, and X^{a} is a single bond, —O—, —S—, —S(O)—, —S(O)₂—, —C(O)—, or a C₁₋₁₃ alkylidene of formula-C(R^{c})(R^{d})— wherein R^{e} and R^{d} are each independently hydrogen or C₁₋₁₂ alkyl, or a group of the formula —C(═R^{e})— wherein R^{e} is a divalent C₁₋₁₂ hydrocarbon group. The bisphenol ester units can be bisphenol A phthalate ester units of the formula (3b)

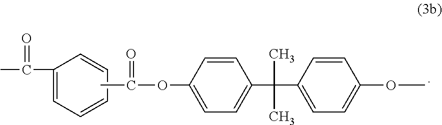

In an aspect, the poly(bisphenol A carbonate-co-isophthalate/terephthalate-resorcinol ester) (4c) comprises 1-90 mol % of bisphenol A carbonate units, 10-99 mol % of isophthalic acid-terephthalic acid-resorcinol ester units, and optionally 1-60 mol % of resorcinol carbonate units, isophthalic acid-terephthalic acid-bisphenol A phthalate ester units, or a combination thereof. In another aspect, poly(bisphenol A carbonate-co-isophthalate/terephthalate resorcinol ester) (6) comprises 10-20 mol % of bisphenol A carbonate units, 20-98 mol % of isophthalic acid-terephthalic acid-resorcinol ester units, and optionally 1-60 mol % of resorcinol carbonate units, isophthalic acid-terephthalic acid-bisphenol A phthalate ester units, or a combination thereof.

The high heat poly(ester-carbonate) s can have an Mw of 2,000-100,000 g/mol, preferably 3,000-75,000 g/mol, more preferably 4,000-50,000 g/mol, more preferably 5,000-35,000 g/mol, and still more preferably 17,000-30,000 g/mol. Molecular weight determinations are performed using GPC using a cross linked styrene-divinyl benzene column, at a sample concentration of 1 milligram per milliliter, according to polystyrene standards and calculated for polycarbonate. Samples are eluted at a flow rate of 1.0 ml/min with methylene chloride as the eluent.

The poly(carbonate-siloxane) composition of the thermoplastic compositions includes one or poly(carbonate siloxanes). The polysiloxane blocks comprise repeating diorganosiloxane units as in formula (10)

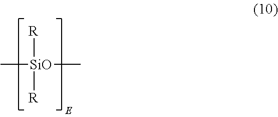

wherein each R is independently a C₁₋₁₃ monovalent organic group. For example, R can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups can be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups can be used in the same copolymer.

The value of E in formula (10) can vary widely depending on the type and relative amount of each component in the thermoplastic composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it can be desirable to use a relatively larger amount of the poly(carbonate-siloxane) copolymer. Conversely, where E is of a higher value, e.g., greater than 40, a relatively lower amount of the poly(carbonate-siloxane) copolymer can be used. A combination of a first and a second (or more) poly(carbonate-siloxane) copolymers can be used, wherein the average value of E of the first copolymer is less than the average value of E of the second copolymer.

In an aspect, the polysiloxane blocks are of formula (11)

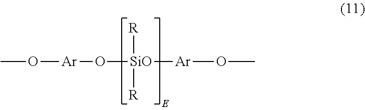

wherein E and R are as defined if formula (10); each R can be the same or different, and is as defined above; and Ar can be the same or different, and is a substituted or unsubstituted C₆₋₃₀ arylene, wherein the bonds are directly connected to an aromatic moiety. Ar groups in formula (11) can be derived from a C₆₋₃₀ dihydroxyarylene compound, for example a dihydroxyarylene compound of formula (3) or (6). Dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-bydroxyphenyl)cyclohexane, bis(4-hydroxyphenyl sulfide), and 1,1-bis(4-hydroxy-t-butylphenyl) propane.

In another aspect, polysiloxane blocks are of formula (13)

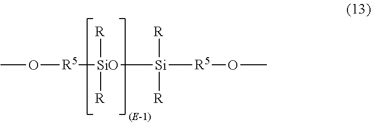

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (14):

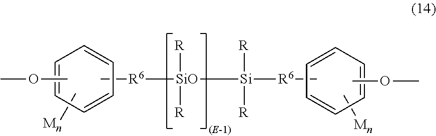

wherein R and E are as defined above. R⁶ in formula (14) is a divalent C₂₋₈ aliphatic group. Each M in formula (14) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

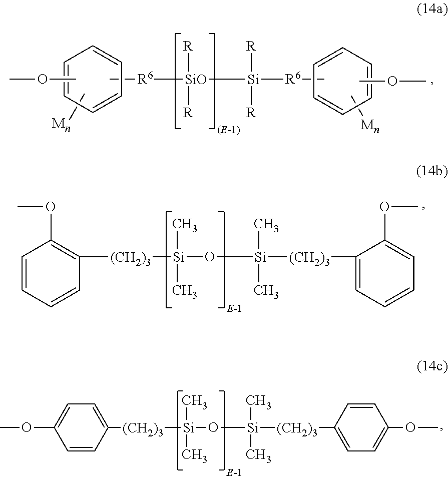

or a combination thereof, wherein E has an average value of 2 to 200, 2 to 125, 5 to 125, 5 to 100, 5 to 50, 20 to 80, or 5 to 20.

Blocks of formula (14) can be derived from the corresponding dihydroxy polysiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers can then be manufactured, for example, by the synthetic procedure of European Patent Application Publication No. 0 524 731 A1 of Hoover, page 5, Preparation 2.

Transparent poly(carbonate-siloxane) copolymers comprise carbonate units (1) derived from bisphenol A, and repeating siloxane units (14a), (14b), (14c), or a combination thereof (preferably of formula 14a), wherein E has an average value of 4 to 50, 4 to 15, preferably 5 to 15, more preferably 6 to 15, and still more preferably 7 to 10. The transparent copolymers can be manufactured using one or both of the tube reactor processes described in U.S. Patent Application No. 2004/0039145A1 or the process described in U.S. Pat. No. 6,723,864 can be used to synthesize the poly(carbonate-siloxane) copolymers.

The poly(carbonate-siloxane) composition of the thermoplastic compositions includes one or more poly(carbonate siloxane) s. The poly(carbonate-siloxane) compositions include a poly(carbonate-siloxane) comprising 30 to 70 wt % siloxane repeating units, based on the weight of the poly(carbonate-siloxane). Within this range, the poly(carbonate-siloxane) can have 35 to 70 wt %, or 35 to 65 wt %, or 35-55 wt %, or 35-45 wt % siloxane repeating units.

The poly(carbonate-siloxane) compositions can include one or more poly(carbonate-siloxane) s comprising 30 to 70 wt % siloxane repeating units. When the poly(carbonate-siloxane) composition is limited to one or more poly(carbonate-siloxane) s comprising 30 to 70 wt % siloxane repeating units and does not include one or more auxiliary poly(carbonate-siloxane) copolymers comprising 2 wt % to less than 30 wt % siloxane repeating units, then the one or more poly(carbonate-siloxane) s comprising 30 to 70 wt % siloxane repeating units are present in an amount effective to provide less than 6 wt % siloxane repeating units, or 2 to less than 6 wt %, based on the weight of the thermoplastic composition. In such aspects, a polycarbonate is present. The polycarbonate includes a linear homopolycarbonate, a poly(phthalate-carbonate), or a combination thereof. In some aspects, the polycarbonate is a linear homopolycarbonate. In some aspects, the polycarbonate is a combination of a linear homopolycarbonate and a poly(phthalate-carbonate).

In some aspects, the poly(carbonate-siloxane) composition includes combination one or more poly(carbonate-siloxanes) comprising 30 to 70 wt % siloxane repeating units and one or more auxiliary poly(carbonate-siloxane) comprising 2 wt % to less than 30 wt % siloxane repeating units.

The auxiliary poly(carbonate-siloxane) s can have 10 to less than 30 wt % siloxane repeating units, based on the total weight of the poly(carbonate-siloxane). Within this range, the poly(carbonate-siloxane) copolymer can have 15 to 25 wt % siloxane repeating units.

The auxiliary poly(carbonate-siloxane) can have 2 to less than 10 wt % siloxane repeating units, based on the total weight of the poly(carbonate-siloxane). Within this range, the poly(carbonate-siloxane) can have 4 to less than 10 wt % siloxane repeating units.

The auxiliary poly(carbonate siloxane) can include one or more poly(carbonate-siloxane) copolymers comprising 10 to less than 30 wt % siloxane repeating units and one or more poly(carbonate-siloxane) copolymers comprising 2 to less than 10 wt % siloxane repeating units.

When the poly(carbonate siloxane) composition includes an auxiliary poly(carbonate-siloxane) comprising 2 wt % to less than 30 wt % siloxane repeating units, then the poly(carbonate-siloxane) comprising 30 to 70 wt % siloxane repeating units can be present in amount effective to provide up to 6 wt %, or 0.5-6 wt % siloxane repeating units and the poly(carbonate-siloxane) comprising 2 wt % to less than 30 wt % siloxane repeating units can be present in an amount effective to provide up to 6 wt %, or 0.5-6 wt %, based on the total weight of the thermoplastic composition. Together the poly(carbonate-siloxane) comprising 30 to 70 wt % siloxane repeating units and the auxiliary poly(carbonate-siloxane) can be present in an amount effective to provide up to 10 wt %, or 2-10 wt % siloxane repeating units, based on the total weight of the thermoplastic composition.

When the poly(carbonate siloxane) composition includes one or more poly(carbonate-siloxane) copolymers comprising 10 to less than 30 wt % siloxane repeating units and one or more poly(carbonate-siloxane) s comprising 30 to 70 wt % siloxane repeating units, then the poly(carbonate-siloxane) copolymer comprising 10 to less than 30 wt % siloxane repeating units may be present in an amount effective to provide up to 6 wt %, 0.5-6 wt %, 0.5-5 wt %, 0.5-4 wt %, 1-6 wt %, 1-5 wt %, or 1-4 wt % siloxane repeating units and the one or more poly(carbonate-siloxane) s comprising 30 to 70 wt % siloxane repeating units may be present in an amount effective to provide up to 6 wt %, 0.5-6 wt %, 0.5-5 wt %, 0.5-4 wt %, 1-6 wt %, 1-5 wt %, or 1-4 wt % siloxane repeating units, each based on the total weight of the composition.

When the poly(carbonate siloxane) composition includes one or more poly(carbonate-siloxane) copolymers comprising 2 to less than 10 wt % siloxane repeating units and one or more poly(carbonate-siloxane) s comprising 30 to 70 wt % siloxane repeating units, then the poly(carbonate-siloxane) copolymer comprising 2 to less than 10 wt % siloxane repeating units may be present in an amount effective to provide up to 6 wt %, 0.5-6 wt %, 0.5-5 wt %, 0.5-4 wt %, 1-6 wt %, 1-5 wt %, or 1-4 wt % siloxane repeating units and the one or more poly(carbonate-siloxane) s comprising 30 to 70 wt % siloxane repeating units may be present in an amount effective to provide up to 6 wt %, 0.5-6 wt %, 0.5-5 wt %, 0.5-4 wt %, 0.5-3 wt %, or 0.5-2 wt %, 1-6 wt %, 1-5 wt %, 1-4 wt %, 1-3 wt %, or 1-2 wt % siloxane repeating units, each based on the total weight of the composition.

In an aspect, a blend is used, in particular a blend of a bisphenol A homopolycarbonate and a poly(carbonate-siloxane) block copolymer of bisphenol A blocks and eugenol capped polydimethylsiloxane blocks, of the formula

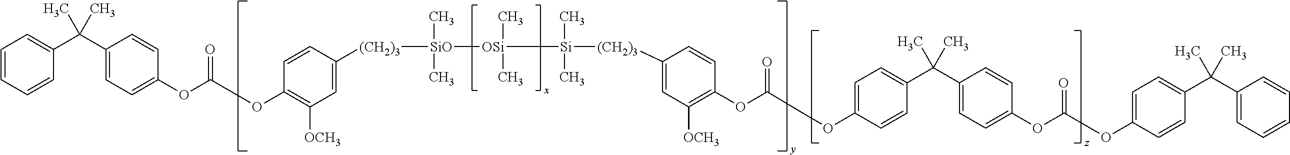

wherein x is 1 to 200, preferably 5 to 85, preferably 10 to 70, preferably 15 to 65, and more preferably 40 to 60; x is 1 to 500, or 10 to 200, and z is 1 to 1000, or 10 to 800. In an aspect, x is 1 to 200, y is 1 to 90 and z is 1 to 600, and in another aspect, x is 30 to 50, y is 10 to 30 and z is 45 to 600. The polysiloxane blocks can be randomly distributed or controlled distributed among the polycarbonate blocks.

Poly(carbonate-siloxane) s can have a weight average molecular weight of 2,000 to 100,000 g/mol, preferably 5,000 to 50,000 g/mol as measured by gel permeation chromatography using a crosslinked styrene-divinyl benzene column, at a sample concentration of 1 milligram per milliliter, and as calibrated for polystyrene and calculated for polycarbonate.

The poly(carbonate-siloxane) s can have a melt volume flow rate, measured at 300° C./1.2 kg, of 1 to 50 cubic centimeters per 10 minutes (cc/10 min), preferably 2 to 30 cc/10 min. Combinations of the poly(carbonate-siloxane) s of different flow properties can be used to achieve the overall desired flow property.

The thermoplastic compositions can include various additives ordinarily incorporated into polymer compositions of this type, with the proviso that the additive(s) are selected so as to not significantly adversely affect the desired properties of the thermoplastic composition, in particular chemical resistance and ultrasonic weldability (e.g., weld strength). Such additives can be mixed at a suitable time during the mixing of the components for forming the composition. Additives include fillers, reinforcing agents, antioxidants, beat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. In general, the additives are used in the amounts generally known to be effective. For example, the total amount of the additives (other than any impact modifier, filler, or reinforcing agents) can be 0.01 to 10 wt %, based on the total weight of the thermoplastic composition.

The thermoplastic compositions can include a flame retardant. Useful flame retardants include organic compounds that include phosphorous, bromine, chlorine, or fluorine. Non-brominated and non-chlorinated phosphorous-containing flame retardants can be preferred in certain applications for regulatory reasons, for example organic phosphates and organic compounds containing phosphorous-nitrogen bonds. Thus, the thermoplastic compositions can be essentially halogen-free. As used herein, the phrase “essentially halogen-free” is as defined by IEC 61249-2-21 or UL 746H. According to the International Electrochemical Commission, Restriction Use of Halogen (IEC 61249-2-21), a composition should include 900 parts per million (ppm) or less of each of chlorine and bromine and also include 1500 ppm or less of total bromine, chlorine, and fluorine content. According to UL 746H, a composition should include 900 ppm or less of each of chlorine, bromine, and fluorine and 1500 ppm or less of the total chlorine, bromine, and fluorine content. The bromine, chlorine, and fluorine content in ppm may be calculated from the composition or measured by elemental analysis techniques.

Inorganic flame retardants can also be used, for example salts of C₂₋₁₆ alkyl sulfonates such as potassium perfluorobutane sulfonate (Rimar salt), potassium perfluoroctane sulfonate, and tetraethylammonium perfluorohexane sulfonate, salts of aromatic sulfonates such as sodium benzene sulfonate, sodium toluene sulfonate (NATS), and the like, salts of aromatic sulfone sulfonates such as potassium diphenylsulfone sulfonate (KSS), and the like; salts formed by reacting for example an alkali metal or alkaline earth metal (e.g., lithium, sodium, potassium, magnesium, calcium and barium salts) and an inorganic acid complex salt, for example, an oxo-anion (e.g., alkali metal and alkaline-earth metal salts of carbonic acid, such as Na₂CO₃, K₂CO₃, MgCO₃, CaCO₃, and BaCO₃, or a fluoro-anion complex such as Li₃AlF₆, BaSiF₆, KBF₄, K₃AlF₆, KAlF₄, K₂SiF₆, or Na₃AlF₆ or the like. Rimar salt and KSS and NATS, alone or in combination with other flame retardants, are particularly useful. Rimar salt and KSS and NATS, alone or in combination with other flame retardants, are particularly useful. The perfluoroalkyl sulfonate salt can be present in an amount of 0.30 to 1.00 wt %, preferably, 0.40 to 0.80 wt %, more preferably, 0.45 to 0.70 wt %, based on the total weight of the composition. The aromatic sulfonate salt can be present in the final thermoplastic composition in an amount of 0.01 to 0.1 wt %, preferably, 0.02 to 0.06 wt %, and more preferably, 0.03 to 0.05 wt %. Exemplary amounts of aromatic sulfone sulfonate salt can be 0.01 to 0.6 wt %, preferably, 0.1 to 0.4 wt %, and more preferably, 0.25 to 0.35 wt %, based on the total weight of the thermoplastic composition.

Halogenated materials can also be used as flame retardants, for example halogenated compounds and polymers of formula (20):

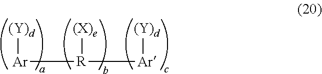

wherein R is an alkylene, alkylidene, or cycloaliphatic linkage (e.g., methylene, ethylene, propylene, isopropylene, isopropylidene, butylene, isobutylene, amylene, cyclohexylene, cyclopentylidene, and the like), a linkage selected from oxygen ether, carbonyl, amine, a sulfur containing linkage (e.g., sulfide, sulfoxide, or sulfone), a phosphorous containing linkage, and the like, or R can also consist of two or more alkylene or alkylidene linkages connected by such groups as aromatic, amino, ether, carbonyl, sulfide, sulfoxide, sulfone, a phosphorous containing linkage, and the like; Ar and Ar′ can be the same or different and are mono- or polycarbocyclic aromatic groups such as phenylene, biphenylene, terphenylene, naphthylene, and the like; Y is an organic, inorganic or organometallic radical such as halogen (e.g., chlorine, bromine, iodine, or fluorine), ether group of the general formula OE wherein E is a monovalent hydrocarbon radical similar to X, monovalent hydrocarbon groups of the type represented by R, or other substituents (e.g., nitro, cyano, or the like), the substituents being essentially inert provided there be at least one and preferably two halogen atoms per aryl nucleus; each X is the same or different, and is a monovalent hydrocarbon group such as alkyl (e.g., methyl, ethyl, propyl, isopropyl, butyl, decyl, and the like, aryl ((e.g., phenyl, naphthyl, biphenyl, xylyl, tolyl, and the like), arylalkylene (e.g., as benzyl, ethylenephenyl, and the like), cycloaliphatic (e.g., cyclopentyl, cyclohexyl, and the like), as well as monovalent hydrocarbon groups containing inert substituents therein; the letter d represents a whole number from 1 to a maximum equivalent to the number of replaceable hydrogens substituted on the aromatic rings comprising Ar or Ar′; the letter e represents a whole number from 0 to a maximum equivalent to the number of replaceable hydrogens on R; the letters a, b, and c represent whole numbers including 0, provided that when b is not 0, neither a nor c can be 0, or that either a or c, but not both, can be 0, or that where b is 0, the aromatic groups are joined by a direct carbon-carbon bond; the hydroxyl and Y substituents on the aromatic groups, Ar and Ar′ can be varied in the ortho, meta or para positions on the aromatic rings and the groups can be in any possible geometric relationship with respect to one another.

Included within the scope of the above formula are bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl) ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2 bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant.

The flame retardant can include an organophosphorous compound. In the organophosphorous compounds that have at least one organic aromatic group, the aromatic group can be a substituted or unsubstituted C₃-30 group containing one or more of a monocyclic or polycyclic aromatic moiety (which can optionally contain with up to three heteroatoms (N, O, P, S, or Si)) and optionally further containing one or more nonaromatic moieties, for example alkyl, alkenyl, alkynyl, or cycloalkyl. The aromatic moiety of the aromatic group can be directly bonded to the phosphorous-containing group, or bonded via another moiety, for example an alkylene group. The aromatic moiety of the aromatic group can be directly bonded to the phosphorous-containing group, or bonded via another moiety, for example an alkylene group. In an aspect the aromatic group is the same as an aromatic group of the polycarbonate backbone, such as a bisphenol group (e.g., bisphenol A), a monoarylene group (e.g., a 1,3-phenylene or a 1,4-phenylene), or a combination comprising at least one of the foregoing.

The phosphorous-containing group can be a phosphate (P(═O) (OR) 3), phosphite (P(OR)₃), phosphonate (RP(═O)(OR)₂), phosphinate (R₂P(═O)(OR)), phosphine oxide (R₃P(═O)), or phosphine (R₃P), wherein each R in the foregoing phosphorous-containing groups can be the same or different, provided that at least one R is an aromatic group. A combination of different phosphorous-containing groups can be used. The aromatic group can be directly or indirectly bonded to the phosphorous, or to an oxygen of the phosphorous-containing group (i.e., an ester).

In an aspect the aromatic organophosphorous compound is a monomeric phosphate. Representative monomeric aromatic phosphates are of the formula (GO)₃P═O, wherein each G is independently an alkyl, cycloalkyl, aryl, alkylarylene, or arylalkylene group comprising up to 30 carbon atoms, provided that at least one G is an aromatic group. Two of the G groups can be joined together to provide a cyclic group. In some aspects G corresponds to a monomer used to form the polycarbonate, e.g., resorcinol. Exemplary phosphates include phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri (nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

Di- or polyfunctional aromatic organophosphorous compounds are also useful, for example, compounds of the formulas

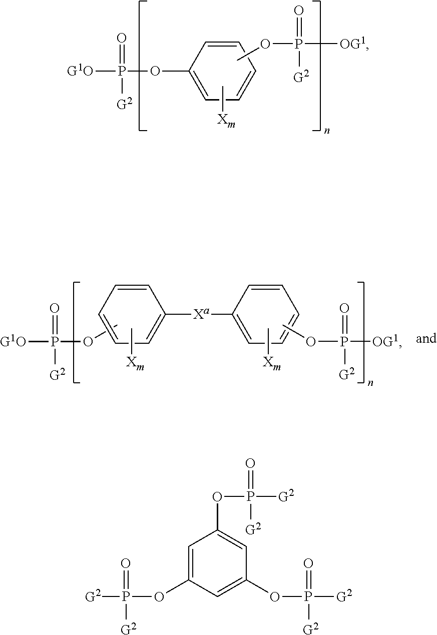

wherein each G¹ is independently a C₁₋₃₀ hydrocarbyl; each G² is independently a C₁₋₃₀ hydrocarbyl or hydrocarbyloxy; X^{a} is as defined in formula (3) or formula (4); each X is independently a bromine or chlorine; m is 0 to 4, and n is 1 to 30. In a specific aspect, X^{a} is a single bond, methylene, isopropylidene, or 3,3,5-trimethylcyclohexylidene.

Specific aromatic organophosphorous compounds are inclusive of acid esters of formula (9)

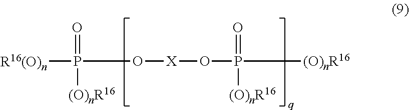

wherein each R¹⁶ is independently C₁₋₈ alkyl, C₅₋₆ cycloalkyl, C₆₋₂₀ aryl, or C₇₋₁₂ arylalkylene, each optionally substituted by C₁₋₁₂ alkyl, specifically by C₁₋₄ alkyl and X is a mono- or poly-nuclear aromatic C₆₋₃₀ moiety or a linear or branched C₂₋₃₀ aliphatic radical, which can be OH-substituted and can contain up to 8 ether bonds, provided that at least one R¹⁶ or X is an aromatic group; each n is independently 0 or 1; and q is from 0.5 to 30. In some aspects each R¹⁶ is independently C₁₋₄ alkyl, naphthyl, phenyl(C₁₋₄) alkylene, aryl groups optionally substituted by C₁₋₄ alkyl; each X is a mono- or poly-nuclear aromatic C₆₋₃₀ moiety, each n is 1; and q is from 0.5 to 30. In some aspects each R¹⁶ is aromatic, e.g., phenyl; each X is a mono- or poly-nuclear aromatic C₆₋₃₀ moiety, including a moiety derived from formula (2); n is one; and q is from 0.8 to 15. In other aspects, each R¹⁶ is phenyl; X is cresyl, xylenyl, propylphenyl, or butylphenyl, one of the following divalent groups

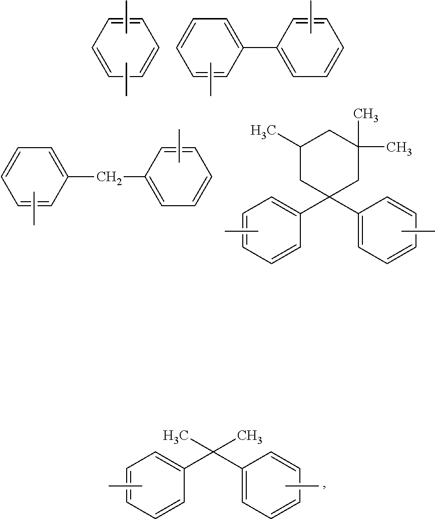

or a combination comprising one or more of the foregoing; n is 1; and q is from 1 to 5, or from 1 to 2. In some aspects at least one R¹⁶ or X corresponds to a monomer used to form the polycarbonate, e.g., bisphenol A, resorcinol, or the like. Aromatic organophosphorous compounds of this type include the bis(diphenyl) phosphate of hydroquinone, resorcinol bis(diphenyl phosphate) (RDP), and bisphenol A bis(diphenyl) phosphate (BPADP), and their oligomeric and polymeric counterparts.

The organophosphorous flame retardant containing a phosphorous-nitrogen bond can be a phosphazene, phosphonitrilic chloride, phosphorous ester amide, phosphoric acid amide, phosphonic acid amide, phosphinic acid amide, or tris(aziridinyl) phosphine oxide. These flame-retardant additives are commercially available. In an aspect, the organophosphorous flame retardant containing a phosphorous-nitrogen bond is a phosphazene or cyclic phosphazene of the formulas

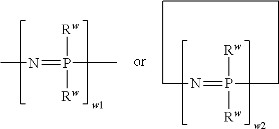

wherein w1 is 3 to 10,000; w2 is 3 to 25, or 3 to 7; and each R^{w} is independently a C₁₋₁₂ alkyl, alkenyl, alkoxy, aryl, aryloxy, or polyoxyalkylene group. In the foregoing groups at least one bydrogen atom of these groups can be substituted with a group comprising an N, S, O, or F atom, or an amino group. For example, each R^{w} can be a substituted or unsubstituted phenoxy, an amino, or a polyoxyalkylene group. Any given R^{w} can further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. In an aspect, the phosphazene has a structure represented by the formula

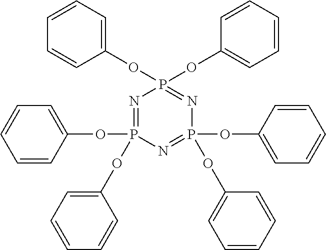 [SMILES: c1ccc(OP2(Oc3ccccc3)=NP(Oc3ccccc3)(Oc3ccccc3)=NP(Oc3ccccc3)(Oc3ccccc3)=N2)cc1]

Commercially available phenoxyphosphazenes comprising the aforementioned structures are LY202 manufactured and distributed by Lanyin Chemical Co., Ltd, FP-110 manufactured and distributed by Fushimi Pharmaceutical Co., Ltd, and SPB-100 manufactured and distributed by Otsuka Chemical Co., Ltd.

When present, phosphorous-containing flame retardants are generally present in an amount effective to provide up to 2 wt % phosphorous, based on the total weight of the thermoplastic composition.

Anti-drip agents can also be used in the composition, for example a fibril forming or non-fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. An TSAN comprises 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Antidrip agents can be used in amounts of 0.1-5 wt %, or 0.1-1.0 wt %, based on the total weight of the thermoplastic composition.

The thermoplastic compositions can be manufactured by various methods. For example, the components are first blended, optionally with fillers in a HENSCHEL-Mixer® high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat or downstream through a sidestuffer. Additives can also be compounded into a masterbatch with a desired polymeric polymer and fed into the extruder. The extruder is generally operated at a temperature higher than that necessary to cause the composition to flow. The extrudate is immediately quenched in a water bath and pelletized. The pellets so prepared can be one-fourth inch long or less as desired. Such pellets can be used for subsequent molding, shaping, or forming.

Transparent compositions can be produced by manipulation of the process used to manufacture the thermoplastic composition. One example of such a process to produce transparent thermoplastic compositions is described in U.S. Patent Application No. 2003/0032725.

Ultrasonically weldable shaped, formed, or molded thermoplastic parts comprising the thermoplastic compositions are also provided. The thermoplastic compositions can be molded into useful shaped parts by a variety of methods, such as injection molding, extrusion, rotational molding, blow molding and thermoforming.

Ultrasonically welded articles can be prepared using an ultrasonic welding device and the parts prepared from the thermoplastic compositions. The above-described ultrasonically weldable shaped, formed, or molded thermoplastic parts that are to be joined together using ultrasonic welding can be placed one on top of the other on a supportive surface (i.e., “fixture”). A titanium or plated aluminum component (i.e., “horn”) is brought into contact with the upper thermoplastic part. Pressure is applied to the horn clamping the thermoplastic parts together against the fixture. The horn is then vibrated vertically e.g., 15 kHz or 30 kHz times per second for a pre-determined time (i.e. “weld time”). The mechanical vibrations are transmitted through the thermoplastic parts to the joint interface to create frictional heat. When the temperature at the joint interface reaches the melting point, the thermoplastic composition melts and flows and the vibration is stopped so that the thermoplastic composition begins to cool. The clamping force is maintained for a predetermined time (i.e., “hold time”) to allow the thermoplastic parts to fuse as the melted thermoplastic cools and solidifies. Once the melted thermoplastic has solidified, the clamping force is removed and the horn is retracted. The thermoplastic parts now joined is removed from the fixture as one part (i.e., the ultrasonically welded article).

Advantageously, ultrasonic welding avoids the use of solvents, adhesives and mechanical fasteners. Ultrasonic welding assembly can be used in applications such as automotive applications, medical applications, electrical and electronic applications, and consumer applications. Ultrasonic welding of thermoplastics is a joining technique that is especially well suited for medical applications. It prevents the introduction of contaminants or sources of degradation to the weld, producing a medical device essentially free of contaminants, and allows for a very fast and highly reproducible production cycles. Non-limiting examples of medical devices include a syringe, a blood filter housing, a blood bag, a solution bag, an intravenous connector, a dialyzer, a catheter, a medical storage tray, a medical appliance, medical tubing, a cardiac pacemaker, a cardiac defibrillator, a cannula, an implantable prosthesis, a cardiac assist device, a heart valve, a vascular graft, an extra-corporeal device, an artificial organ, a pacemaker lead, a defibrillator lead, a blood pump, a balloon pump, an A-V shunt, a membrane for cell encapsulation, a wound dressing, an artificial joint, an orthopedic implant a Petrie dish, a face shield, a respirator, a sensor, and an autoclavable article (e.g., a medical or scientific device or a food handling device, either of which can be a tray, dish, syringe, container, or the like).

Ultrasonic welding also enables the joining of complex parts, such as, for example, to provide ultrasonically welded articles for electronics applications. Non-limiting examples include computer and business machine housings such as housings for monitors, handheld electronic device housings such as housings for cell phones, and electrical connectors.

This disclosure is further illustrated by the following examples, which are non-limiting.

### EXAMPLES

The following components are used in the examples. Unless specifically indicated otherwise, the amount of each component is in wt %, based on the total weight of the composition.

The materials shown in Table 1 were used.

TABLE 1

| | | |
|---|---|---|
| PC-1 | Linear poly(bisphenol A carbonate), Mw = 20,000-22,000 g/mol per GPC using | SABIC |
| | polystyrene standards and calculated for polycarbonate | |
| PC-2 | Linear poly(bisphenol A carbonate), Mw = 30,000-31,000 g/mol per GPC using | SABIC |
| | polystyrene standards and calculated for polycarbonate | |
| PC-3 | Linear poly(bisphenol A carbonate), Mw = 18,000-20,000 g/mol per GPC using | SABIC |
| | polystyrene standards and calculated for polycarbonate | |
| PC-4 | Poly(bisphenol A carbonate-bisphenol A phthalate) comprising 19-21 wt % | SABIC |
| | bisphenol A carbonate units and 79-81 wt % bisphenol A phthalate groups with an | |
| | isophthalate:terephthalate ratio of 93:7; Mw = 27,000-29,000 as per GPC using | |
| | polystyrene standards and calculated for polycarbonate, para-cumyl phenol (PCP) | |
| | end-capped | |
| PC-Si-1 | PDMS (polydimethylsiloxane)-Bisphenol A polycarbonate copolymer, 6 wt % | SABIC |
| | siloxane repeating units, average PDMS block length 45 units (D45), Mw 22,000- | |
| | 24,000 g/mol as determined by GPC using polycarbonate standards, eugenol end- | |
| | capped | |
| PC-Si-2 | PDMS (polydimethylsiloxane)-Bisphenol A polycarbonate copolymer, 20 wt % | SABIC |
| | siloxane repeating units, average PDMS block length 45 units (D45), Mw 29,000- | |
| | 31,000 g/mol as determined by GPC using polycarbonate standards, eugenol end- | |
| | capped | |
| PC-Si-3 | Polycarbonate-siloxane copolymer comprising 40 wt % siloxane repeating units, | SABIC |
| | average PDMS block length of 45 units, comprising a Mw of 37,000 to 38,000 | |
| | grams per mole as determined by GPC using polystyrene standards and calculated | |
| | for polycarbonate, produced by interfacial polymerization and endcapped with p- | |
| | cumylphenol | |
| P-FR | Phenoxycyclophosphazene; obtained as RABITLE FP-110 | Fushimi |
| | | Pharmaceutical |
| | | Co., Ltd. |
| ANTI- | Encapsulated Polytetrafluoroethylene, CAS Reg. No. 9002-84-0, with 47-53 wt % | SABIC |
| DRIP | PTFE | |
| UVA-1 | 2-[2-hydroxy-3,5-di-(1,1-dimethylbenyl)]-2H-benzotriazol, available as UVA | BASF Corp. |
| | 234 | |
| UVA-2 | 2-(2H-benzotriazol-2-yl)-4-(1,1,3,3-tetramethylbutyl)phenol | CYTEC |
| PETS | Pentaerythritol tetrastearate, >90% esterified | Faci |
| TBPP | Tris(2,4-di-tert-butylphenyl) phosphite, CAS Reg. No. 31570-04-4; available as | BASF Corp. |
| | IRGAFOS 168 | |

The testing samples were prepared as described below and the following test methods were used.

Typical compounding procedures are described as follows: The various formulations were prepared by direct dry-blending of the raw materials and homogenized with a paint shaker prior to compounding. The formulations were compounded on a 25 mm Werner Pfleiderer ZSK co-rotating twin-screw extruder. A typical extrusion profile is listed in Table 2.

TABLE 2

| Parameters | Unit | 25 mm ZSK |
|---|---|---|
| Die | — | |
| Feed temperature | ° C. | 40 |
| Zone 1 temp. | ° C. | 200 |
| Zone 2 temp | ° C. | 240-250 |
| Zone 3-9 | | 260-300 |
| Die temperature | | 300 |
| Screw speed | rpm | 300 |
| Throughput | kg/h | ~18 |
| Vacuum 1 | bar | 0.7 |

The formulations were molded into weld test cups on an Arburg 520S molding machine with a closing force of 130T. The molding conditions for Examples 1-5 are listed in Table 3.

TABLE 3

| | | #1 | #2 | #3 | #4 | #5 |
|---|---|---|---|---|---|---|
| Temperature | Zone 1 | 80 | 80 | 80 | 80 | 80 |
| (° C.) | Zone 2 | 270 | 230 | 250 | 250 | 260 |
| | Zone 3 | 280 | 240 | 260 | 260 | 270 |
| | Zone 4 | 290 | 250 | 270 | 270 | 280 |
| | Zone 5 | 300 | 260 | 280 | 280 | 290 |
| | Zone 6 | 300 | 260 | 280 | 280 | 290 |
| | hotrunner | 300 | 260 | 280 | 280 | 290 |
| | mould | 90 | 90 | 90 | 90 | 90 |
| Time (sec) | cycle | 36 | 36 | 36 | 36 | 36 |
| | cooling | 20 | 20 | 20 | 20 | 20 |
| | injection | 5 | 5 | 5 | 5 | 5 |
| injection speed (cm³/sec) | | 10 | 10 | 10 | 10 | 10 |
| pressure (bar) | switch | 800 | 750 | 1100 | 1250 | 2500 |
| | pressure | | | | | |
| | backpressure | 550 | 550 | 550 | 550 | 550 |
| volume (cm³) | buffer | 2.6 | 2.6 | 11.9 | 0 | 2.6 |
| | shot | 30 | 30 | 30 | 30 | 30 |
| | switch | 12 | 12 | 12 | 12 | 12 |

Ultrasonic welding was performed on a BRANSON X2000 ultrasonic welder. The BRANSON X2000 includes a convertor of 20 kHz amplitude and a fixed horn with a factor of 2.3. A black booster (factor 2.5X) was used, which delivers a maximum amplitude of 115 μm. In the ultrasonic welding process two parts are joined together. The two parts are called the energy director and energy absorber. The energy director is mainly triangular) (90° which transfers the energy to the peak that result in a heat build-up in that small contact area. This area melts and flows across the energy absorber to form the weld.

Tensile strength was determined on the welded test cups with a LLOYD LR30K tensile testing machine with a 10KN loadcell at room temperature. The tensile strength was measured on the welded cups was with a special tool to fit in the cups with a constant speed of 10 mm/min. To calculate the strength value in MPa the area (mm²) and force at failure (N) is needed. Calculation is as follows: Strength (MPa)=Force at failure (N) divided by the area of the weld cup (mm²).

Atomic force microscopy (AFM) experiments were performed using a Dimension FastScan AFM system (Dimension FastScan, Bruker, Santa Barbara, USA). Software Nanoscope Analysis 9.4 from Bruker was used as the computer interface for operation and Nanoscope Analysis 2.0 from Bruker was used for the analysis of the AFM measurements. All AFM measurements were performed at ambient conditions. For rubber distribution characterization, the AFM tapping mode in the FastScan mode was used with a frequency of 4 Hz utilizing FastScan mode AFM tips (Model FastScan-A, k: 18 N/m, f: 1400 kHz).

By using a full factorial design of experiment (DoE), directions of the equipment settings were defined to obtain as high as possible weld strength. Three settings, amplitude, weld force and down speed, were used in this study as variables. The output is weld strength and cycle time. Table 4 summarizes the welding parameters for the DOE study.

TABLE 4
Settings

| DOE | −1 | −0.5 | 0 | 0.5 | 1 |
|---|---|---|---|---|---|
| Amplitude (%) | 30 | 43 | 55 | 68 | 80 |
| Amplitude (μm) | 35 | 49 | 63 | 78 | 92 |
| Weld force (N) | 100 | 225 | 350 | 475 | 600 |
| Down speed (%) | 40 | 50 | 60 | 70 | 80 |

### Examples 1-10

Table 5 shows the compositions and properties for the following comparative examples and examples. Comparative examples are indicated with an asterisk.

TABLE 5

| | Unit | 1* | 2* | 3 | 4 | 5* | 6* | 7 | 8 | 9* | 10* |
|---|---|---|---|---|---|---|---|---|---|---|---|
| PC-1 | wt % | 73.01 | 73 | 53.24 | 32.5 | 38.3 | 32.34 | 9.81 | 17.64 | 78.895 | |
| PC-2 | wt % | 8 | 6.3 | 31.67 | 32.41 | 38.3 | | | 19.37 | 6 | |
| PC-3 | wt % | | | | | | | | | | 62.44 |
| PC-4 | wt % | | | | 20.0 | | | | | | |
| PC-Si-1 | wt % | | | | | | 59.7 | 82 | 50 | | 37.5 |
| PC-Si-2 | wt % | | | | | 22.2 | 4.97 | | | 14 | |
| PC-Si-3 | wt % | 15 | 15 | 11.1 | 11.1 | | | 5.2 | 10 | | |
| TBPP | wt % | 0.09 | 0.10 | 0.09 | 0.09 | 0.09 | 0.09 | 0.09 | 0.09 | 0.03 | 0.06 |
| UVA | wt % | 0.3 | | 0.3 | 0.3 | 0.3 | 0.3 | 0.3 | 0.3 | 0.3 | |
| PETS | wt % | 0.1 | 0.3 | 0.1 | 0.1 | 0.3 | | | | | |
| ANTI- | wt % | 0.5 | 0.3 | 0.5 | 0.5 | 0.3 | | | | | |
| DRIP | | | | | | | | | | | |
| P-FR | wt % | 3 | | 3 | 3 | | 2 | 2 | 2 | | |
| Total | wt % | 100 | 100 | 100 | 100 | 100 | 100 | 100 | 100 | 100 | |
| Si content | wt % | 6 | 6 | 4.44 | 4.44 | 4.44 | 4.46 | 7 | 7 | 2.8 | 2.25 |

Molded samples of the thermoplastic compositions of Table 5 were evaluated for ultrasonic welding performance. Comparative Examples 1-2 were not readily welded with an ultrasonic welder, whereas Examples 3-10 were welded with optimized settings. Consistent with this observation, the contour maps (data not shown) of Comparative Examples 1-2 from the DoE studies were darker shades of blue, indicating that the weld strength was low, ranging up to 15 MPa. Examples 3 and Comparative Examples 9 and 10 have a mixture of light blue (weld strength 10-25 MPa) and green (weld strength greater than 25 MPa) on the contour maps (data not shown). The contour maps of Examples 4, 7, and 8 and Comparative Examples 5-6 are entirely green, indicating a weld strength greater than 25 MPa (data not shown).

In addition to a good weld strength, the ultrasonically welded article should also have good chemical resistance as determined according to ASTM D-543. In particular, good chemical resistance can be demonstrated by the retention (expressed in %) of tensile stress at yield/break and tensile elongation at break. Chemical resistance will be evaluated on 3.2 mm ASTM tensile bars at 23° C. after exposure to a chemical agent. In particular, the ASTM tensile bars are bent to specific strain levels (e.g., 0.5% or 1% in a test fixture) and the bars are kept in constant exposure to the strain and chemical agent for a specified test period. Bars may be wrapped so that they are kept saturated while in contact with the strained area. After a pre-determined amount of time, the retention (expressed in %) of tensile stress at yield/break and tensile elongation at break are measured. The yield stress retention should be greater than 90% and the elongation at break retention should be from 80 to 139%.

As previously discussed, it is known that poly(carbonate siloxanes) comprising a wt % of siloxane repeating units of less than 30 wt %, as is the case with PC—Si-1 (6 wt %) and PC—Si-2) (20 wt %) have inadequate chemical resistance when a poly(carbonate siloxane) comprising 30-70 wt % siloxane repeating units is not present. Specifically, the yield stress retention is 80-89%, or greater than 90% and the elongation at break retention is 65-79%, or outside of the range of 80 to 139%. Thus, the thermoplastic compositions of Table 5 where a poly(carbonate siloxane) comprising 30-70 wt % siloxane repeating units is absent are expected to have inadequate chemical resistance when tested and are therefore comparative examples (see Comparative Examples 5-6 and 9-10).

It would be expected that there would be some vibration loss due to the viscous behavior of the rubber. However, the weldability of the compositions of Table 5 does not necessarily correlate with the total siloxane content of the compositions. For example, Comparative Examples 1-2 comprising 6 wt % siloxane repeating units are not weldable, whereas Comparative Examples 9-10 comprising a higher siloxane content than 6 wt % (i.e., 7 wt %) than Comparative Examples 1-2 are weldable as are Example 3-4 comprising a lower siloxane content than 6 wt % (i.e., 4.44 wt %).

Instead of total siloxane content of the total thermoplastic compositions determining the ultrasonic weldability of the thermoplastic compositions, the examples show that the particular poly(carbonate-siloxane) copolymers that are present and the contributions of siloxane content of each respective poly(carbonate-siloxane) copolymer affects the ultrasonic weldability. When the poly(carbonate-siloxane) comprising 40 wt % is the only poly(carbonate-siloxane) present in the thermoplastic composition, then the calculated wt % of siloxane repeating units should be less than 6 wt % (compare Example 3 with Comparative Examples 1-2). When the poly(carbonate-siloxane) comprising 40 wt % is in combination with another poly(carbonate siloxane), the siloxane content of the composition can exceed 6 wt % (see Examples 7-8). Furthermore, in Examples 7-8, of the 7 wt % siloxane content, the contribution to the siloxane content from the poly(carbonate-siloxane) comprising 40 wt % siloxane (PC—Si-3) can be greater (Example 8) or less (Example 7) than the contribution to the siloxane content from the poly(carbonate-siloxane) comprising 6 wt % siloxane (PC—Si-1). Specifically, in Example 7, the total siloxane content is 7 wt % with 2.08 wt % from PC—Si-3 and 4.92 wt % from PC—Si-1. In Example 8, the total siloxane content is also 7 wt %, with 4 wt % from PC—Si-3 and 3 wt % from PC—Si-1.

Comparative Examples 1, 5, and 6 and Example 8 were selected for morphology measurements. For morphology analysis, a cross-section of each sample was prepared using a microtome and then a flat cross-section was prepared at −120° C. using microtoming equipment (LEICA EM UC7) to obtain a flat cross-sectional surface suitable for AFM measurements without further surface treatment. A diamond knife (Diatome) mounted in a stainless steel holder was used for preparing the samples.

Comparative Examples 1, 5, and 6 and Example 8 which were selected for morphology measurements each had a different combination of total siloxane content and type of poly(carbonate-siloxane. FIGS. 11-12 show the morphology comparison at 2 μm and 5 μm, respectively. Comparative Example 1 including 15% of a poly(carbonate siloxane) comprising a 40 wt % siloxane repeating units, shows large siloxane domains with irregular shapes. Comparative Example 5, which includes a poly(carbonate siloxane) comprising 20 wt % siloxane repeating units, the siloxane domain is smaller than Comparative Example 1. Comparative Example 6 includes a mixture of a poly(carbonate siloxane) comprising 20 wt % and a poly(carbonate siloxane) comprising 6 wt %. The siloxane domains of Comparative Example 6 are more homogenous than Comparative Example 1 and Comparative Example 5. Example 8 includes a mixture of a poly(carbonate siloxane) comprising 40 wt % siloxane repeating units and a poly(carbonate siloxane) comprising 6 wt % siloxane repeating units. The siloxane domains of Example 8 are more homogenous than Comparative Examples 1 and 5-6.

This disclosure further encompasses the following aspects.

Aspect 1. An ultrasonically weldable part comprising a thermoplastic composition comprising a poly(carbonate-siloxane) composition comprising a poly(carbonate-siloxane) comprising 30 to 70 wt % siloxane repeating units present in an amount effective to provide less than 6 wt % siloxane repeating units, based on the total weight of the thermoplastic composition, or a poly(carbonate-siloxane) comprising 30 to 70 wt % siloxane repeating units and a poly(carbonate-siloxane) comprising 2 wt % to less than 30 wt % siloxane repeating units, optionally, a polycarbonate, and optionally an additive composition, wherein the siloxane domain of a molded sample of the thermoplastic composition has an average diameter of 70 nm or less, measured using atomic force microscopy.

Aspect 1a. The ultrasonically weldable part of aspect 1 comprising a thermoplastic composition comprising a poly(carbonate-siloxane) comprising 30 to 70 wt % siloxane repeating units present in an amount effective to provide less than 6 wt % siloxane repeating units and a poly(carbonate-siloxane) comprising 2 wt % to less than 30 wt % siloxane repeating units.

Aspect 2. The ultrasonically weldable part of aspect 1 comprising a % retention of yield at stress is greater than 90%, and a % retention of elongation at break is from 80 to 139%, each determined according to ASTM D543 using a 3.2 mm thick ASTM bar under 0.5% strain or under 1% strain at 23° C. after 24 h exposure to a cleaning agent.

Aspect 3. The ultrasonically weldable part of aspect 1 or aspect 2, wherein the poly(carbonate-siloxane) comprising 2 wt % to less than 30 wt % siloxane repeating units comprises a poly(carbonate-siloxane) comprising 2 to less than 10 wt % siloxane repeating units, a poly(carbonate-siloxane) comprising 10 to less than 30 wt % siloxane repeating units, or a combination thereof.

Aspect 3a. The ultrasonically weldable part of aspect 1 or aspect 2, wherein the poly(carbonate-siloxane) comprising 2 wt % to less than 30 wt % siloxane repeating units comprises a poly(carbonate-siloxane) comprises a poly(carbonate-siloxane) comprising 2 to less than 10 wt % siloxane repeating units present in an amount effective to provide up to 6 wt %, 0.5-6 wt %, 0.5-5 wt %, 0.5-4 wt %, 1-6 wt %, 1-5 wt %, or 1-4 wt % siloxane repeating units and the poly(carbonate-siloxane) comprising 30 to 70 wt % siloxane repeating units is present in an amount effective to provide up to 6 wt %, 0.5-6 wt %, 0.5-5 wt %, 0.5-4 wt %, 1-6 wt %, 1-5 wt %, or 1-4 wt % siloxane repeating units, each based on the total weight of the composition.

Aspect 3b. The ultrasonically weldable part of aspect 1 or aspect 2, wherein the poly(carbonate-siloxane) comprising 2 wt % to less than 30 wt % siloxane repeating units comprises a poly(carbonate-siloxane) comprises a poly(carbonate-siloxane) comprising 10 to less than 30 wt % siloxane repeating units present in an amount effective to provide up to 6 wt %, 0.5-6 wt %, 0.5-5 wt %, 0.5-4 wt %, 1-6 wt %, 1-5 wt %, or 1-4 wt % siloxane repeating units and the poly(carbonate-siloxane) comprising 30 to 70 wt % siloxane repeating units is present in an amount effective to provide up to 6 wt %, 0.5-6 wt %, 0.5-5 wt %, 0.5-4 wt %, 0.5-3 wt %, or 0.5-2 wt %, 1-6 wt %, 1-5 wt %, 1-4 wt %, 1-3 wt %, or 1-2 wt % siloxane repeating units, each based on the total weight of the composition.

Aspect 3c. The ultrasonically weldable part of aspect 1 or aspect 2, wherein the poly(carbonate-siloxane) comprising 2 wt % to less than 30 wt % siloxane repeating units comprises a poly(carbonate-siloxane) comprising 10 to less than 30 wt % siloxane repeating units and a poly(carbonate-siloxane) comprising 2 wt % to less than 10 wt % siloxane repeating units, wherein the poly(carbonate-siloxane) comprising 10 to less than 30 wt % siloxane repeating units and the poly(carbonate-siloxane) comprising 2 wt % to less than 10 wt % siloxane repeating units are present in an amount effective to provide up to 6 wt %, 0.5-6 wt %, 0.5-5 wt %, 0.5-4 wt %, 1-6 wt %, 1-5 wt %, or 1-4 wt % siloxane repeating units and the poly(carbonate-siloxane) comprising 30 to 70 wt % siloxane repeating units is present in an amount effective to provide up to 6 wt %, 0.5-6 wt %, 0.5-5 wt %, 0.5-4 wt %, 0.5-3 wt %, or 0.5-2 wt %, 1-6 wt %, 1-5 wt %, 1-4 wt %, 1-3 wt %, or 1-2 wt % siloxane repeating units, each based on the total weight of the composition.

Aspect 4. The ultrasonically weldable part of any one of the preceding aspects, wherein the polycarbonate is present and comprises a linear homopolycarbonate, a poly(phthalate-carbonate), or a combination thereof.

Aspect 5. The ultrasonically weldable part of any one of the preceding aspects, wherein the polycarbonate is present and comprises a linear homopolycarbonate, or a linear homopolycarbonate and a poly(phthalate-carbonate).

Aspect 6. The ultrasonically weldable part of any one of the preceding aspects, wherein the poly(carbonate-siloxane) composition is present in an amount effective to provide 2 to less than 10 wt % siloxane repeating units, based on the total weight of the thermoplastic composition.

Aspect 6. The ultrasonically weldable part of any one of the preceding aspects, wherein the polycarbonate is present and comprises a linear homopolycarbonate comprising a molecular weight of 15,000 to 25,000 grams per mole, preferably 19,000 to 23,000 grams per mole, a linear homopolycarbonate comprising a molecular weight of 25,000 to 35,000 grams per mole, preferably 28,000 to 33,000 grams per mole, or a combination thereof, each as measured by gel permeation chromatography according to polystyrene standards and calculated for polycarbonate.

Aspect 7. The ultrasonically weldable part of any one of the preceding aspects, wherein the thermoplastic composition comprises a polycarbonate comprising a linear homopolycarbonate, a poly(phthalate-carbonate), or a combination thereof, a poly(carbonate-siloxane) composition, wherein the poly(carbonate-siloxane) composition is a poly(carbonate-siloxane) comprising 30-70 wt % siloxane repeating units present in an amount effective to provide less than 6 wt % siloxane repeating units, based on the total weight of the composition, and optionally an additive composition.

Aspect 8. The ultrasonically weldable part of any one of the preceding aspects, wherein the thermoplastic composition comprises a polycarbonate comprising a linear homopolycarbonate, a poly(phthalate-carbonate), or a combination thereof, and a poly(carbonate-siloxane) composition, wherein the poly(carbonate-siloxane) composition is a poly(carbonate-siloxane) comprising 30-70 wt % siloxane repeating units present in an amount effective to provide less than 6 wt % siloxane repeating units, based on the total weight of the thermoplastic composition, and optionally an additive composition.

Aspect 9. The ultrasonically weldable part of any one of the preceding aspects, wherein the thermoplastic composition comprises a polycarbonate comprising a linear homopolycarbonate, or a linear homopolycarbonate and a poly(phthalate-carbonate), and a poly(carbonate-siloxane) composition, wherein the poly(carbonate-siloxane) composition is a poly(carbonate-siloxane) comprising 30 to 70 wt % siloxane repeating units present in amount effective to provide 2 to 10 wt % siloxane repeating units to the total thermoplastic composition, and optionally, an additive composition.

Aspect 10. The ultrasonically weldable part of any one of the preceding aspects, wherein the thermoplastic composition comprises a poly(carbonate-siloxane) comprising 30 to 70 wt % siloxane repeating units, and a poly(carbonate-siloxane) comprising 10 to less than 30 wt % siloxane repeating units, a poly(carbonate-siloxane) comprising 2 to less than 10 wt % siloxane repeating units, or a combination thereof, and optionally, an additive composition, wherein the poly(carbonate-siloxane) s are together present in amount effective to provide 2 to 10 wt % siloxane repeating units to the total thermoplastic composition.

Aspect 10a. The ultrasonically weldable part of any one of the preceding aspects, wherein the poly(carbonate-siloxane) composition comprises a poly(carbonate-siloxane) comprising 30 to 70 wt % siloxane repeating units present in an amount effective to provide 0.5-3 wt % siloxane repeating units and a poly(carbonate-siloxane) comprising 2 to less than 10 wt % siloxane repeating units present in an amount effective to provide 1-6 wt % siloxane repeating units.

Aspect 10a-1. The ultrasonically weldable part of any one of the preceding aspects, wherein the poly(carbonate-siloxane) composition comprises a poly(carbonate-siloxane) comprising 30 to 70 wt % siloxane repeating units present in an amount effective to provide 1.5 to 2.5 wt % siloxane repeating units and a poly(carbonate-siloxane) comprising 2 to less than 10 wt % siloxane repeating units present in an amount effective to provide 4 to 6 wt % siloxane repeating units.

Aspect 10b. The ultrasonically weldable part of any one of the preceding aspects, wherein the poly(carbonate-siloxane) composition comprises a poly(carbonate-siloxane) comprising 30 to 70 wt % siloxane repeating units present in an amount effective to provide 1 to 6 wt % siloxane repeating units and a poly(carbonate-siloxane) comprising 2 to less than 10 wt % siloxane repeating units present in an amount effective to provide 1 to 5 wt % siloxane repeating units.

Aspect 10b-1. The ultrasonically weldable part of any one of the preceding aspects, wherein the poly(carbonate-siloxane) composition comprises a poly(carbonate-siloxane) comprising 30 to 70 wt % siloxane repeating units present in an amount effective to provide 4 to 6 wt % siloxane repeating units and a poly(carbonate-siloxane) comprising 2 to less than 10 wt % siloxane repeating units present in an amount effective to provide 2 to 4 wt % siloxane repeating units.

Aspect 11. The ultrasonically weldable part of any one of the preceding aspects, wherein the additive composition comprises a flow modifier, a filler, a reinforcing agent, an antioxidant, a heat stabilizer, a light stabilizer, an ultraviolet light stabilizer, a UV absorbing additive, a plasticizer, a lubricant, a release agent, an antistatic agent, an anti-fog agent, an antimicrobial agent, a colorant, a surface effect additive, a radiation stabilizer, a flame retardant, an anti-drip agent, or a combination thereof.

Aspect 12. A method for forming the ultrasonically weldable part comprising molding, extruding, or shaping the thermoplastic composition of any of the preceding aspects to form the ultrasonically weldable part.

Aspect 13. An ultrasonically welded article comprising the ultrasonically weldable part of any one of aspects 1-11.

Aspect 14. A method for forming the ultrasonically welded article comprising ultrasonically welding the ultrasonically weldable part according to any one of aspects 1-11 to another thermoplastic part to provide the ultrasonically welded article.

Aspect 15. The method of aspect 13, wherein the thermoplastic part is an ultrasonically weldable part according to any one of aspects 1-11.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group comprising at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group comprising one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O) 2-aryl) a thiol (—SH), a thiocyano (—SCN), a tosyl(CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. An ultrasonically weldable part comprising a thermoplastic composition comprising:
a poly(carbonate-siloxane) composition comprising:
a poly(carbonate-siloxane) comprising 30 to 70 wt % siloxane repeating units present in an amount effective to provide less than 6 wt % siloxane repeating units, based on the total weight of the thermoplastic composition, or
a poly(carbonate-siloxane) comprising 30 to 70 wt % siloxane repeating units and a poly(carbonate-siloxane) comprising 2 wt % to less than 30 wt % siloxane repeating units,
optionally, a polycarbonate, and
optionally an additive composition,
wherein the siloxane domain of a molded sample of the thermoplastic composition has an average diameter of 70 nm or less, measured using atomic force microscopy.

2. The ultrasonically weldable part of claim 1 comprising:
a % retention of yield at stress is greater than 90%, and
a % retention of elongation at break is from 80 to 139%,
each determined according to ASTM D543 using a 3.2 mm thick ASTM bar under 0-1% strain at 23° C. after 24 h exposure to a cleaning agent.

3. The ultrasonically weldable part of claim 1, wherein the poly(carbonate-siloxane) comprising 2 wt % to less than 30 wt % siloxane repeating units comprises:
a poly(carbonate-siloxane) comprising 2 to less than 10 wt % siloxane repeating units,
a poly(carbonate-siloxane) comprising 10 to less than 30 wt % siloxane repeating units, or a combination thereof.

4. The ultrasonically weldable part of claim 1, wherein the polycarbonate is present and comprises a linear homopolycarbonate, a poly(phthalate-carbonate), or a combination thereof.

5. The ultrasonically weldable part of claim 1, wherein the polycarbonate is present and comprises
a linear homopolycarbonate, or
a linear homopolycarbonate and a poly(phthalate-carbonate).

6. The ultrasonically weldable part of claim 1, wherein the poly(carbonate-siloxane) composition is present in an amount effective to provide 2 to less than 10 wt % siloxane repeating units, based on the total weight of the composition.

7. The ultrasonically weldable part of claim 1, wherein the polycarbonate is present and comprises
a linear homopolycarbonate comprising a weight average molecular weight of 15,000 to 25,000 grams per mole, preferably 19,000 to 23,000 grams per mole,
a linear homopolycarbonate comprising a weight average molecular weight of 25,000 to 35,000 grams per mole, preferably 28,000 to 33,000 grams per mole,
or a combination thereof, each as measured by gel permeation chromatography according to polystyrene standards and calculated for polycarbonate.

8. The ultrasonically weldable part of claim 1, wherein the thermoplastic composition comprises
a polycarbonate comprising a linear homopolycarbonate, a poly(phthalate-carbonate), or a combination thereof,
a poly(carbonate-siloxane) composition, wherein the poly(carbonate-siloxane) composition is a poly(carbonate-siloxane) comprising 30-70 wt % siloxane repeating units present in an amount effective to provide less than 6 wt % siloxane repeating units, based on the total weight of the thermoplastic composition, and
optionally an additive composition.

9. The ultrasonically weldable part of claim 1, wherein the thermoplastic composition comprises
a polycarbonate comprising
a linear homopolycarbonate, or
a linear homopolycarbonate and a poly(phthalate-carbonate), and
a poly(carbonate-siloxane) composition, wherein the poly(carbonate-siloxane) composition is a poly(carbonate-siloxane) comprising 30-70 wt % siloxane repeating units present in an amount effective to provide less than 6 wt % siloxane repeating units, based on the total weight of the thermoplastic composition, and
optionally an additive composition.

10. The ultrasonically weldable part of claim 1, wherein the thermoplastic composition comprises
a poly(carbonate-siloxane) comprising 30 to 70 wt % siloxane repeating units, and
a poly(carbonate-siloxane) comprising 10 to less than 30 wt % siloxane repeating units,
a poly(carbonate-siloxane) comprising 2 to less than 10 wt % siloxane repeating units,
or a combination thereof, and
optionally, an additive composition,
wherein the poly(carbonate-siloxane) s are together present in amount effective to provide 2 to 10 wt % siloxane repeating units to the total thermoplastic composition.

11. The ultrasonically weldable part of claim 1, wherein the additive composition comprises a flow modifier, a filler, a reinforcing agent, an antioxidant, a heat stabilizer, a light stabilizer, an ultraviolet light stabilizer, a UV absorbing additive, a plasticizer, a lubricant, a release agent, an antistatic agent, an anti-fog agent, an antimicrobial agent, a colorant, a surface effect additive, a radiation stabilizer, a flame retardant, an anti-drip agent, or a combination thereof.

12. A method for forming the ultrasonically weldable part of claim 1 comprising molding, extruding, or shaping the thermoplastic composition of any one of the preceding claims to form the ultrasonically weldable part.

13. An ultrasonically welded article comprising the ultrasonically weldable part of claim 1.

14. A method for forming an ultrasonically welded article comprising ultrasonically welding the ultrasonically weldable part according to claim 1 to another thermoplastic part to provide the ultrasonically welded article.

15. The method of claim 14, wherein the thermoplastic part is an ultrasonically weldable part according to claim 1.
